(19) United States
(12) Patent Application Publication
(10) Pub. No.: US 2012/0179721 A1
(43) Pub. Date: Jul. 12, 2012

(54) Fitness Function Analysis System and Analysis Method Thereof

(75) Inventors: Tsung-Jung HSIEH, Hsinchu (TW); Wei-Chang YEH, Hsinchu City (TW)

(73) Assignee: NATIONAL TSING HUA UNIVERSITY, Hsinchu (TW)

(21) Appl. No.: 13/162,859

(22) Filed: Jun. 17, 2011

(30) Foreign Application Priority Data
Jan. 11, 2011 (TW) 100101028

(51) Int. Cl. G06F 17/30

(52) U.S. Cl. 707/780; 707/E17.014

(57) ABSTRACT

The present invention discloses a fitness function analysis system and an analysis method thereof. Wherein, an initializing module initiates a plurality of reference solutions. Based on fitness functions of reference solutions, a searching module searches a fitness function adjacent to the fitness functions. While an adjacent fitness function close to the fitness function is greater than the fitness function, the searching module replaces the fitness function by the adjacent fitness function. A calculating module calculates the proportion of any fitness function to the summation of the fitness functions. While the searching module counts the number of times that the searching module has searched an adjacent function close to the fitness function, the number of times exceeds a threshold value, and there is no adjacent fitness function greater than the fitness function, a processing module will generate another fitness function corresponding to the fitness function and compare the two fitness functions.

### BACKGROUND OF THE INVENTION

1. Field of the Invention

The present invention relates to a fitness function analysis system and an analysis method thereof, and more particularly to a fitness function analysis system and an analysis method thereof capable of achieving a prediction analysis effectively.

2. Description of Related Art

As global economy and stock market grow rapidly in recent years, stock price prediction becomes an important subject for both companies and individuals. As to companies, an accurate stock price prediction is applied to banks, stocks and securities, or venture capitals for a more efficient investment plan to create higher profit. As to individual investors, the accurate stock price prediction can provide a stock price trend and lower the risk of investments.

In addition to the technical analysis and basic analysis, conventional stock price predictions adopt the popular neural network prediction model, and researches indicated that the use of the neural network as the stock price prediction model has a relatively accurate prediction performance. However, the application of neural networks on the stock price prediction is very limited due to the lack of comprehensive network architectures and parameter selection mechanisms, such that the practical applicability of the stock price prediction is lowered.

Since many factors affect the stock price and correlations exist among variables, therefore selection used as a parameter of the neural network model becomes an influential factor of a stock price and the most important index of an accurate predicted stock price. For example, if there is no specific method for the decision of hidden layers of interactions among inputted parameters of a recurrent neural network. If too many parameters are used in the hidden layer of a complicated model, the network will lack of the ability of mathematical induction. If too few parameters are used in the hidden layer, the network will be unable to obtain an accurate prediction result. Such conventional prediction method always gives a prediction result with an error, and thus a design of a fitness function analysis system and an analysis method thereof is an important subject that demands immediate attentions and feasible solutions.

### SUMMARY OF THE INVENTION

In view of the problems of the prior art, it is a primary objective of the present invention to provide a fitness function analysis system and an analysis method thereof to overcome the problems of the conventional prediction methods having too many complicated parameters that cause a complicated prediction and an inaccurate prediction result.

To achieve the foregoing objective, the present invention provides a fitness function analysis system comprising: an initializing module, a searching module, a calculating module and a processing module. The initializing module initializes a plurality of reference solutions. The searching module is coupled to the initializing module for finding an adjacent reference solution and an adjacent fitness function within a range with a distance from each fitness function according to a fitness function of each of the reference solutions. When the adjacent fitness function within the range of one of the fitness functions is greater than the fitness function, the searching module will replace the fitness function by the adjacent fitness function, such that the adjacent fitness function becomes a new the fitness function. The calculating module is coupled to the searching module for calculating the proportion of any one of the fitness functions in the summation of the plurality of fitness functions. The processing module is coupled to the initializing module, the searching module and the calculating module, such that if the number of times for the searching module finds the adjacent reference solution and the adjacent fitness function within a range with a distance from one of the fitness functions exceeds a threshold, but still no adjacent fitness function greater than one of the fitness functions is found, then the processing module will generate another fitness function corresponding to one of the fitness functions.

To achieve the foregoing objective, the present invention further provides a fitness function analysis method comprising the steps of: initializing a plurality of reference solutions by an initializing module; finding an adjacent reference solution and an adjacent fitness function within a range with a distance from each fitness function by a searching module, according to a fitness function of each of the reference solutions; replacing the fitness function by the adjacent fitness function by the searching module, if the adjacent fitness function within the range of one of the fitness functions is greater than the fitness function, such that the adjacent fitness function becomes a new fitness function; calculating the proportion of any one of the fitness functions in the summation of the plurality of fitness functions by a calculating module; and generating another fitness function corresponding to one of the fitness functions by a processing module, if the number of times for the searching module finds the adjacent reference solution and the adjacent fitness function within a range with a distance from one of the fitness functions exceeds a threshold, but still finding no adjacent fitness function greater than one of the fitness functions.

Wherein, the processing module replaces one of the fitness functions by the other fitness function if the processing module determines that the other fitness function is greater than one of the fitness functions, such that the other fitness function becomes a new fitness function.

Wherein, each of the reference solutions is a multi-dimensional vector, and the dimension of the multi-dimensional vector is equal to the number of optimal parameters.

Wherein, the threshold is equal to the number of the plurality of reference solutions multiplied by the dimension of the multi-dimensional vector.

Wherein, the processing module controls the searching module and the calculating module to stop each searching and processing after the processing module has received a stop signal.

Wherein, the processing module randomly generates the other fitness function corresponding to one of the fitness functions.

In summation, the fitness function analysis system and analysis method of the present invention have one or more of the following advantages:

(1) The fitness function analysis system and analysis method in accordance with the present invention can optimize the weighted value and error of the recursive neural network in the design of a parametric space. In other words, the invention uses the neural network as a base in conjunction with the parameter optimization and algorithm development to reduce the prediction error, so as to enhance the ability of predicting the stock price.

(2) The fitness function analysis system and analysis method in accordance with the present invention can optimize the weighted value and error of the recursive neural network in the design of a parametric space. In other words, the invention uses the neural network as a base in conjunction with the parameter optimization and algorithm development to reduce the prediction error, and the invention is used in many prediction areas, such as the prediction of an electric bill of the coming day.

### BRIEF DESCRIPTION OF THE DRAWINGS

FIG. 1 is a block diagram of a fitness function analysis system in accordance with a preferred embodiment of the present invention;

FIG. 2 is a schematic diagram of a recursive neural network in accordance with a preferred embodiment of the present invention; and

FIG. 3 is a flow chart of a fitness function analysis method of the present invention.

### DETAILED DESCRIPTION OF THE PREFERRED EMBODIMENTS

The relative variable selection system and selection method thereof in accordance with the present invention will become apparent with the detailed description of preferred embodiments together with related drawings as follows. It is noteworthy to point out that same numerals are used for representing respective elements in the description of the preferred embodiments and the illustration of the drawings.

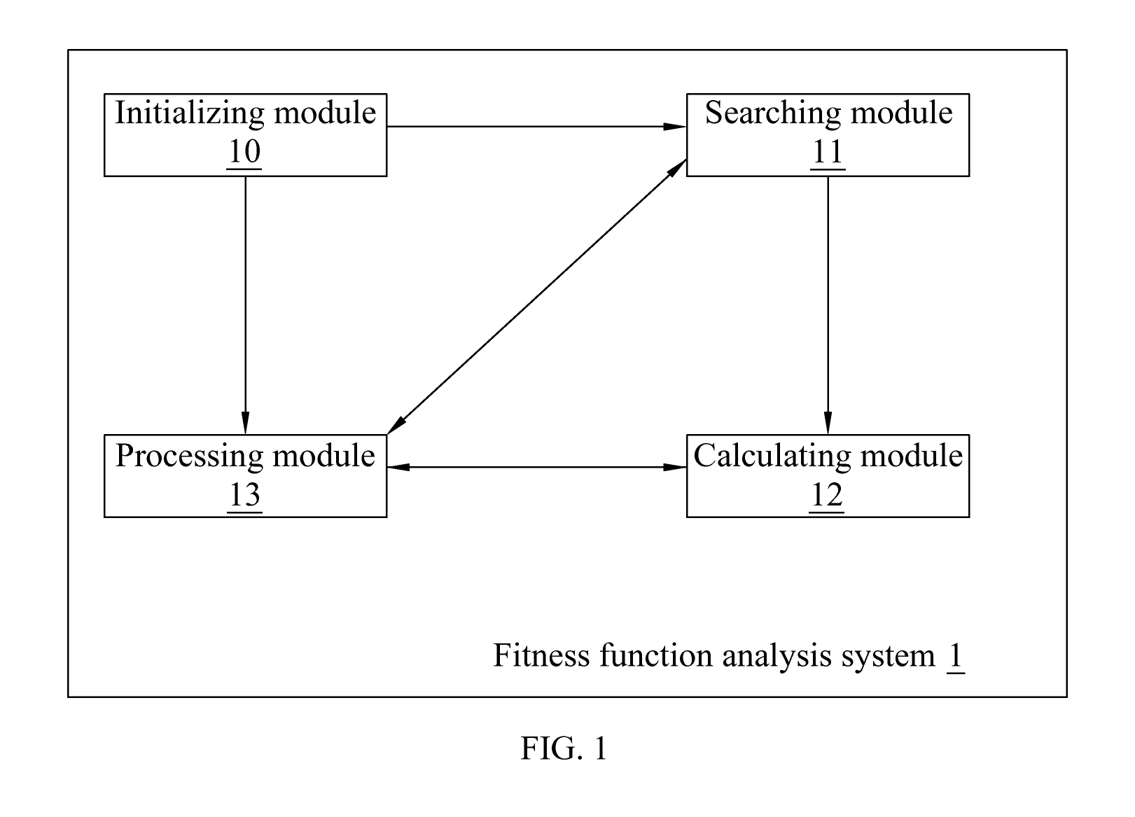

With reference to FIG. 1 for a block diagram of a fitness function analysis system in accordance with a preferred embodiment of the present invention, the fitness function analysis system 1 comprises an initializing module 10, a searching module 11, a calculating module 12 and a processing module 13. The initializing module 10 initializes reference solutions of a plurality of multi-dimensional vectors, wherein the dimension of the multi-dimensional vector is the number of optimal parameters. The searching module 11 is coupled to the initializing module 10 for finding an adjacent reference solution and an adjacent fitness function within a range with a distance from each fitness function according to a fitness function of each of the reference solutions. If the adjacent fitness function in the range of one of the fitness functions is greater than the fitness function, the searching module 11 will replace the fitness function by the adjacent fitness function, such that the adjacent fitness function becomes a new fitness function. The calculating module 12 is coupled to the searching module 11 for calculating the proportion of any one of the fitness functions in the summation of the plurality of fitness functions.

The processing module 13 is coupled to the initializing module 10, searching module 11 and calculating module 12. If the number of times for the searching module 11 finding the adjacent reference solution and the adjacent fitness function in a range with a distance from one of the fitness functions exceeds a threshold and no adjacent fitness function greater than one of the fitness functions is found, the processing module 13 will randomly generate another fitness function corresponding to one of the fitness functions. Wherein, the threshold is equal to the number of the plurality of reference solutions multiplied by the dimension of the multi-dimensional vector. If the processing module 13 determines that the other fitness function is greater than one of the fitness functions, the processing module 13 will replace one of the fitness functions by the other fitness function, such that the other fitness function becomes a new fitness function. After the processing module 13 has received a stop signal, the processing module 13 controls the searching module 11 and calculating module 12 to stop each searching and processing. The persons ordinarily skilled in the art should understand that the preferred embodiments are provided for illustrating the present invention, but not for limiting the invention. Any combination or separation of the aforementioned functional modules can be made depending on the required design.

In another embodiment, the recursive neural integration analysis system based on the bees algorithm is used for describing the fitness function analysis system and analysis method of the present invention.

Firstly, a fitness function analysis system adopts a selection method that uses a stepwise regression correlation selection (SRCS) to create the choice method of input factors. In this preferred embodiment, data including basic factors and technical factors are listed first. After the data are processed by a wavelet transform, the stepwise regression correlation selection can select the most influential factor.

Wherein, the operating method of the stepwise regression correlation selection is divided into the following stages: Firstly, candidate input factors are loaded into a receiving module, and then a correlation coefficient of each target dependent variable corresponding to each factor is determined, and the absolute values are sorted in a descending order by the correlation coefficients. The input factor with an absolute value of the correlation coefficient smaller than 0.4 is deleted, and the p value of each input factor is used for examining the significance of each factor to a target dependent variable to create a regression model of the target dependent variable.

By using the aforementioned method to select a plurality of factors, it is necessary to further use the F value of each factor to check whether the statistical significance exist. The F value is equal to a mean square regression divided by a mean square error as shown in the following equation:

$$\begin{matrix}{F}_{j} = \frac{MSR ( {X}_{j} \vert {X}_{1} , … , {X}_{j - 1} , {X}_{j + 1} , … , {X}_{k} )}{MSE ( {X}_{1} , … , {X}_{k} )} & ( 1 ) \\ {F}_{j}^{*} = {Max}_{1 \leq j \leq k} ( {F}_{j} ) & ( 2 )\end{matrix}$$

If the F value of a certain factor is smaller than a user-defined threshold, then the factor will not have the statistical significance and will be deleted. If each factor in the regression model examined by the aforementioned method has the statistical significance, then the stepwise regression correlation selection will be terminated.

It is noteworthy to point out that when the stepwise regression correlation selection method is used for selecting important factors, each factor corresponding to the dependent variable must have substantial significance. In this example, the level of significance is set to 0.001. If the p value of a specific variable is smaller than 0.001, the variable is considered as a significant factor and will be added into the regression model. If the p value of a specific variable is greater than 0.001, the variable is considered as a non-significant factor and will be deleted from the regression model.

For the F value, the threshold of this example is set to 4. If the F value of a specific variable is greater than 4, then the variable is considered as a significant factor and will be added into the regression model. If the F value of a specific variable is smaller than 4, then the variable is considered as a non-significant factor and will be deleted from the regression model.

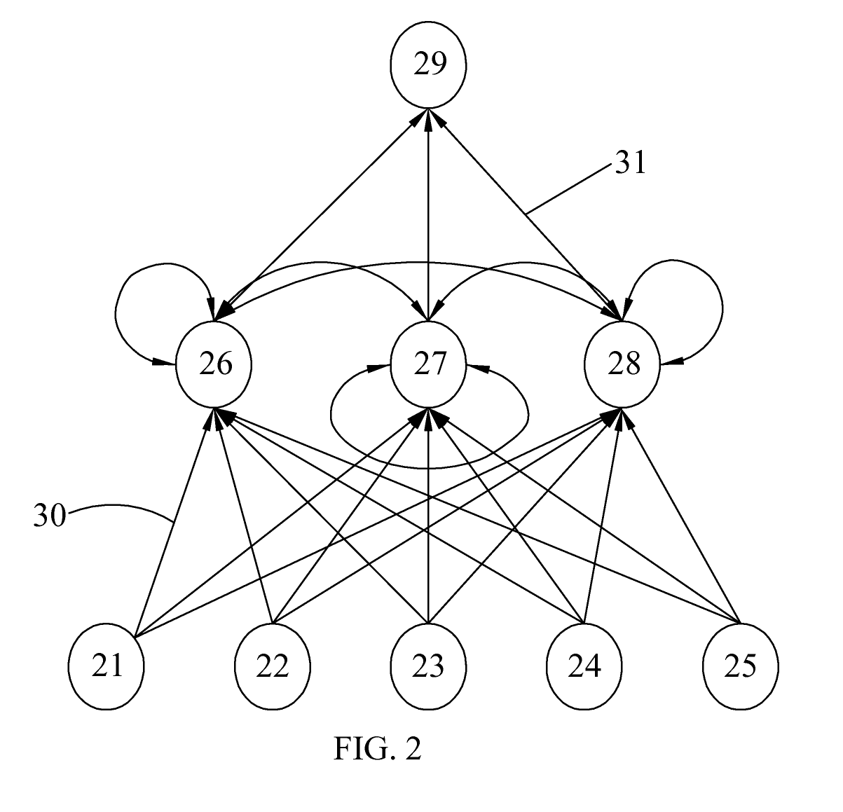

With reference to FIG. 2 for a schematic diagram of a recursive neural network in accordance with a preferred embodiment of the present invention, the advantage of using the recursive neural network is its ability of performing complicated computations and learning a temporal series mode such as a time-variant series. The recursive neural network of this preferred embodiment includes four major portions, respectively: an input layer, a hidden layer, a collection layer and an output layer. Wherein, each hidden neuron is connected to its own or other neuron and each connection have its weighted value and deviation value. The bees algorithm can be used for computing the neural network training process to find the weighted value (w) of each connection between the input layer, hidden layer and output layer and the deviation value (b) of each hidden layer and output layer. In FIG. 2, the input layers are numbered with 21, 22, 23, 24, and 25, the hidden layers are numbered with 26, 27, 28, and the output layers is number with 29. The numeral 30 stands for the weighted value w₆₁ of the portion connected from the input layer 21 to the hidden layer 26, and the numeral 31 stands for the weighted value w₉₈ of the portion connected from the hidden layer 28 to the output layer 29. The weighted values of the connected input layer, hidden layer and output layer can be derived. In addition, the hidden layers 26, 27, 28, and the output layer 29 have the deviation values b₂₆, b₂₇, b₂₈, and b₂₉.

The bees algorithm is a basic recursive algorithm of a group, and the group intelligent behavior of a bee's searching for food can be used for developing an optimization algorithm for searching a food source with the largest amount of nectar. The bees algorithm primarily involve three kinds of bees including the worker bee, patrol bee and scout bee in a colony of bees, and each food source represents a possible solution corresponding to the studied problem, and the quantity of food sources is equal to the number of solutions.

In this preferred embodiment, a number (SN) of initial solutions will be created randomly when the algorithm starts, wherein SN stands for the number of worker bees or patrol bees. The number of worker bees is equal to the number of patrol bees, and each food source which is also the solution Xₕ (h=1, 2, . . . , SN) stands for a one-dimensional vector d, and d is the optimal number of parameters required for the problem. In the entire bees algorithm, the process of finding the solution is limited by the setting of the maximum cycle number (MCN). The search will stop when the set MCN is reached.

After the random initial setting of the food source is completed, a worker bee is placed in an area of each food source, and then the amount of nectar in the food source where each worker bee is located (or the goodness of fit) will be evaluated, and the evaluation is carried out by the goodness of fit function (3) as follows:

$${fit}_{i} = \{ \begin{matrix}\frac{1}{{f}_{i} + 1} , & {f}_{i} \geq 0 \\ 1 + \vert {f}_{i} \vert , & {f}_{i} < 0\end{matrix} \qquad ( 3 )$$

Wherein, fᵢ is the i^{th} solution (food source) of a target function in the problem, and then each worker bee evaluates the goodness of fit of the nearby food source from its own location. If the goodness of fit of the nearby food source is greater than the goodness of fit of the current position of the worker bee, then the worker bee will move to the new food source. The neighbor solution can be found by Equation (4):

Sₕⱼ=Xₕⱼ+u(Xₕⱼ−Xₖⱼ) (4)

Wherein, u is a uniform random variable of [−1, 1], Xₕ=(Xₕ₁, Xₕ₂, . . . , X_{hd}) stands for the location of the current food source, Sₕ stands for another food source near Xₕ, and the difference between Sₕ and Xₕ resides on that Sₕ=(Xₕ₁, Xₕ₂, . . . , Xₕ₍ⱼ₋₁₎, Sₕⱼ, Xₕ₍ⱼ₊₁₎, . . . , X_{hd}). In other words, besides the element of the dimensional parameter j, both elements are equal, and the element situated at j is determined by Equation (4). The parameter j is a randomly selected integer in [1, d].

After the worker bee completes a nearby search, the worker bee will send the final obtained information of the food source to the patrol bee, and the patrol bee starts evaluating the goodness of fit of the nearby food source from the position of the patrol bee. If the goodness of fit of the nearby food source is greater than that of current one, then the patrol bee will shift to the new food source. Similarly, a neighbor solution of the best food source searched by the final worker bee can be found by Equation (2) and used for a further search. Finally, the patrol bee compares the goodness of fit of its own solution with the solution provided by the worker bee based on Equation (5).

$${P}_{h} = \frac{{fit}_{h}}{{\sum }_{h = 1}^{SN} {fit}_{h}} \qquad ( 5 )$$

In Equation (5), the denominator includes the summation of the goodness of fit food of areas searched by patrol bees and provided by worker bees, which stands for the percentage of all possible solutions of the goodness of fit of each food source during the patrol stage, and then the food source with a higher goodness of fit is selected.

It is noteworthy to point out that if a solution processed through a number of tolerance loops as set in Equation (6) in a regression process still cannot generate a better food source, then such solution will be taken over by a scout bee, and a new solution will be generated through Equation (7). If the new solution has a higher goodness fit, then it will replace the previous solution, or else the previous solution will be kept.

limit=SN×d (6)

Xₕ^{j}=Xₘᵢₙ^{j}+rand[0,1](Xₘₐₓ^{j}−Xₘᵢₙ^{j}) (7)

Even though the concept of the fitness function analysis method for the fitness function analysis system of the present invention has been described in the section of the fitness function analysis system, a flow chart is used for illustrating the method as follows.

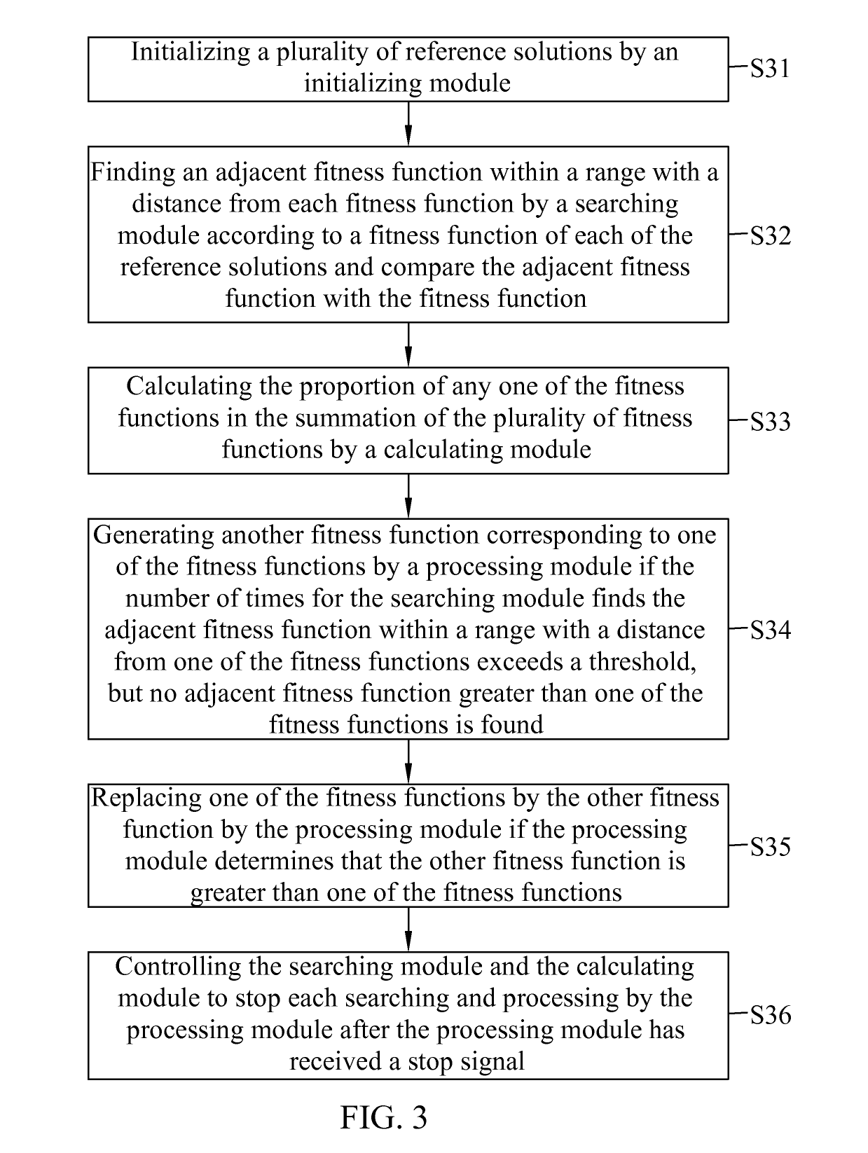

With reference to FIG. 3 for a flow chart of a fitness function analysis method of the present invention, the fitness function analysis method is applied to a fitness function analysis system, and the fitness function analysis system comprises an initializing module, a searching module, a calculating module and a processing module. The fitness function analysis method of the fitness function analysis system comprises the steps of:

(S31) initializing a plurality of reference solutions by an initializing module;

(S32) finding an adjacent reference solution and an adjacent fitness function within a range with a distance from each fitness function by a searching module according to a fitness function of each of the reference solutions;

(S33) replacing the fitness function by the adjacent fitness function by the searching module if the adjacent fitness function within the range of one of the fitness functions is greater than the fitness function, such that the adjacent fitness function becomes a new fitness function;

(S34) calculating the proportion of any one of the fitness functions in the summation of the plurality of fitness functions by a calculating module;

(S35) generating another fitness function corresponding to one of the fitness functions by a processing module if the number of times for the searching module finds the adjacent reference solution and the adjacent fitness function within a range with a distance from one of the fitness functions exceeds a threshold, but no adjacent fitness function greater than one of the fitness functions is found;

(S36) replacing one of the fitness functions by the other fitness function by the processing module if the processing module determines that the other fitness function is greater than one of the fitness functions, such that the other fitness function becomes a new fitness function; and

(S37) controlling the searching module and the calculating module to stop each searching and processing by the processing module after the processing module has received a stop signal.

The details and implementation method of the fitness function analysis method for the fitness function analysis system of the present invention have been described in the aforementioned fitness function analysis system of the present invention, and thus will not be described here again.

In summation of the description above, the fitness function analysis system and analysis method in accordance with the present invention can optimize the weighted value and deviation values effectively in the design of a parametric space. In other words, the neural network is used as a base in conjunction with the parameter optimization and algorithm development to reduce the prediction error. The present invention can be applied in many prediction areas such as the prediction of a stock price or an electric bill of the coming day.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A fitness function analysis system, comprising:
an initializing module, for initializing a plurality of reference solutions;
a searching module, coupled to the initializing module for searching an adjacent reference solution and a adjacent fitness function within a range with a distance from each fitness function, such that if the adjacent fitness function falling within the range of one of the fitness functions is greater than the fitness function, the searching module replaces the fitness function by the adjacent fitness function, and the adjacent fitness function becomes a new fitness function;
a calculating module, coupled to the searching module for calculating the proportion of any fitness function in the summation of the plurality of fitness functions; and
a processing module, coupled to the initializing module, the searching module and the calculating module, such that if the number of times for the searching module finding the adjacent reference solution and the adjacent fitness function within the range with a specific distance from the fitness function exceeds a threshold but still finding no adjacent fitness function greater than one of the fitness functions, the processing module generates another fitness function corresponding to one of the fitness functions.

2. The fitness function analysis system according to claim 1, wherein if the processing module determines that the other fitness function is greater than one of the fitness functions, the processing module replaces one of the fitness functions by the other fitness function, such that the other fitness function becomes a new fitness function.

3. The fitness function analysis system according to claim 1, wherein each of the reference solutions is a multi-dimensional vector and the dimension of the multi-dimensional vector is equal to the number of optimal parameters.

4. The fitness function analysis system according to claim 3, wherein the threshold is equal to the number of the plurality of reference solutions multiplied by the dimension of the multi-dimensional vector.

5. The fitness function analysis system according to claim 1, wherein after the processing module receives a stop signal, the processing module controls the searching module and the calculating module to stop each searching and processing.

6. The fitness function analysis system according to claim 1, wherein the processing module randomly generates the other fitness function corresponding to the fitness function.

7. A fitness function analysis method, comprising steps of:
initializing a plurality of reference solutions by an initializing module;
finding an adjacent reference solution and an adjacent fitness function within a range with a distance from each fitness function by a searching module according to a fitness function of each of the reference solutions;
replacing the fitness function by the adjacent fitness function by the searching module if the adjacent fitness function within the range of one of the fitness functions is greater than the fitness function, such that the adjacent fitness function becomes a new fitness function;
calculating the proportion of any one of the fitness functions in the summation of the plurality of fitness functions by a calculating module; and
generating another fitness function corresponding to one of the fitness functions by a processing module, if the number of times for the searching module finding the adjacent reference solution and the adjacent fitness function within a range with a distance from one of the fitness functions exceeds a threshold, but still finding no adjacent fitness function greater than one of the fitness functions.

8. The fitness function analysis method according to claim 7, further comprising step of: replacing the fitness function by the other fitness function by the processing module if the processing module determines that the other fitness function is greater than one of the fitness functions, such that the other fitness function becomes a new fitness function.

9. The fitness function analysis method according to claim 7, wherein each of the reference solutions is a multi-dimensional vector and the dimension of the multi-dimensional vector is equal to the number of optimal parameters.

10. The fitness function analysis method according to claim 9, wherein the threshold is equal to the number of the plurality of reference solutions multiplied by the dimension of the multi-dimensional vector.

11. The fitness function analysis method according to claim 7, further comprising step of: controlling the searching module and the calculating module by the processing module to stop each searching and processing after the processing module receives a stop signal.

12. The fitness function analysis method according to claim 7, wherein the processing module randomly generates the other fitness function corresponding to one of the fitness functions.
